(19) United States
(12) Patent Application Publication
(10) Pub. No.: US 2013/0046642 A1
(43) Pub. Date: Feb. 21, 2013

(54) SYSTEM AND METHOD FOR COMPUTER-IMPLEMENTED DYNAMIC COORDINATED INTERIOR DESIGN

(71) Applicant: Ralf Georg Jacobus, Malvern, PA (US)

(72) Inventor: Ralf Georg Jacobus, Malvern, PA (US)

(21) Appl. No.: 13/212,003

(22) Filed: Aug. 17, 2011

(51) Int. Cl. G06Q 50/12

(52) U.S. Cl. 705/15

(57) ABSTRACT

A system and method for deploying dynamic experiences within a restaurant using a local machine having a processor, a memory, and a coordination application stored in the memory and executing in the processor. The local machine is further in communication with one computing devices and presentation devices that are affixed to a structure of the restaurant. The method includes loading a first display scheme that provides a first multimedia experience when depicted on the presentation devices and transmitting a first menu scheme to the computing devices that is correlated to the first display. After a time interval, a new display scheme and/or menu scheme can be substituted. Revenue drivers associated with the various schemes can be monitored throughout the operation of the local machine, and can be compared with one another in order to determine preferred and/or optimal display and/or menu schemes.

### TECHNICAL FIELD OF THE INVENTION

This disclosure relates generally to the field of interior design, and, in particular, to computer-implemented systems and methods for deploying one or more dynamic experiences within a restaurant.

### BACKGROUND OF THE INVENTION

The hospitality industry in general, and the restaurant industry in particular, have long been recognized as very difficult areas to establish and maintain a successful business. One factor that contributes to this challenge is the substantial start-up cost/investment that generally must be made prior to opening a restaurant. In addition to the food served, a significant part of the appeal of a restaurant is attributable to the atmosphere/ambiance that the restaurant space provides to the guest. Accordingly, before opening a new restaurant, substantial planning and resources must be invested in order to create a space that diners will enjoy visiting. However, such investments often carry significant risk, as it is often difficult to gauge how diners will react to a restaurant space prior to making this substantial investment.

An additional factor that contributes to the difficulty of succeeding in the restaurant industry is the fickle or transient nature of the dining preferences of many restaurant-goers. While a restaurant may generate significant interest from diners when it first opens, after time diners' interests may shift towards other, newer, restaurants and/or cuisines. Despite the significant efforts that are often invested into the planning and creation of a restaurant's menu, many diners tire of dining from the same menu and/or cuisine, and such diners often have no choice but to seek out new or different restaurants.

Accordingly, it can be appreciated that the principle underlying many of the challenges attendant with launching and maintaining a successful restaurant lie in the inherent uncertainty that accompanies the restaurateur's attempts to accurately devise a combination of ambiance and menu that will attract diners and maintain their interest over time. Additionally, the inherent inflexibility of a given restaurant space's décor/ambiance, as well as technical and logistical challenges that accompany changes to a restaurant's menu, further underscore the significant risk that accompanies restaurant ventures.

Additionally, it should be noted that recent trends in the restaurant industry indicate an increasing popularity in “pop-up” type restaurants, which open (or ‘pop-up’) only for a limited time period (for example, three or six months). Such “pop-up” establishments attempt to capitalize on the referenced transient nature of diner preferences and popularity trends by only intending to remain open for a finite amount of time. However, such “pop-up” ventures also require substantial up-front investment, and also frequently do not provide the same ambiance and/or dining experience of more established, permanent restaurant spaces.

Finally, many restaurants have found that ‘theme nights’ and private parties, where the restaurant space and/or menu are modified and/or enhanced to reflect a certain theme or celebration can be lucrative initiatives. However, such theme nights and celebrations typically require the participating restaurant to invest substantial resources in order to make the necessary changes to the restaurant space (e.g., hanging decorations and posters, modifying the menu, etc.) in order to properly execute such theme nights and celebrations, thereby negating much of the potential revenue increases than would otherwise accompany such events.

It is with respect to these and other considerations that the disclosure made herein is presented.

### SUMMARY OF THE INVENTION

Technologies are presented herein in support of a system and method for deploying one or more dynamic experiences within a restaurant. According to one aspect, a computer-implemented method for deploying one or more dynamic experiences within a restaurant using a local machine is provided, the local machine having a processor, a memory, and a coordination application stored in the memory and executing in the processor. The local machine is further in communication with one or more computing devices and a plurality of presentation devices affixed to a structure of the restaurant. The method includes loading a first display scheme into the memory for depiction on the presentation devices, the first display scheme having one or more coordinated visual arrangements capable of being depicted across the presentation devices to provide a first multimedia experience to the restaurant, and transmitting a first menu scheme to the computing devices, the first menu scheme being correlated to the first display scheme and including one or more food items for selection. The method further includes monitoring a first set of revenue drivers at the local machine, the first set of revenue drivers including one or more indicators relating to a revenue calculation for the restaurant and in association with at least one of the first display scheme and the first menu scheme. After a time interval, the method further includes substituting with the coordination application a second display scheme for the first display scheme, the second display scheme having one or more coordinated visual arrangements capable of being depicted across the presentation devices to provide a second multimedia experience to the restaurant that is different than the first multimedia experience, and transmitting the second menu scheme to the computing devices, the second menu scheme being correlated to the second display scheme and including one or more food items for selection, at least one of which is different than the one or more food items of the first menu scheme. The method further includes monitoring a second set of revenue drivers at the local machine, the second set of revenue drivers including one or more indicators relating to a revenue calculation for the restaurant and in association with at least one of the second display scheme and the second menu scheme. The method further includes comparing the first set of revenue drivers with the second set of revenue drivers to determine at least one of an optimal display scheme and an optimal menu scheme for the restaurant, and outputting at least one of the optimal display scheme and the optimal menu scheme.

According to another aspect, a computer-implemented method for deploying one or more dynamic experiences across a plurality of restaurants using a central machine is provided, the central machine having a processor, a memory, and a coordination application stored in the memory and executing in the processor. The central machine is further in communication with remote machines located at the restaurants, the remote machines further being communication with computing devices and a plurality of presentation devices affixed to respective structures of the restaurants. The method includes transmitting a first display scheme and a first menu scheme to one or more of the remote machines, the first display scheme having one or more coordinated visual arrangements capable of being depicted across the presentation devices and the first menu scheme being correlated to the first display scheme and including one or more food items for selection, and receiving a first set of revenue drivers from one or more of the remote machines, the first set of revenue drivers including one or more indicators relating to a revenue calculation for a respective restaurant and in association with at least one of the first display scheme and the first menu scheme. The method further includes transmitting a second display scheme and a second menu scheme to one or more of the remote machines, the second display scheme being different from the first display scheme and having one or more coordinated visual arrangements capable of being depicted across the presentation devices and the second menu scheme being different from the first menu scheme and being correlated to the second display scheme and comprising one or more food items for selection, and receiving a second set of revenue drivers from one or more of the remote machines, the second set of revenue drivers including one or more indicators relating to a revenue calculation for a respective restaurant and in association with at least one of the second display scheme and the second menu scheme. The method further includes processing the first set of revenue drivers from the remote machines in conjunction with the first display scheme and the first menu scheme and the second set of revenue drivers from the remote machines in conjunction with the second display scheme and the second menu scheme to determine one or more preferred display schemes and one or more preferred menu schemes, and outputting at least one of the preferred display schemes and the preferred menu schemes to at least one of the remote machines.

According to another aspect, a dynamic restaurant experience system is provided. The system includes a processor, a control circuit operatively connected to the processor, a memory operatively connected to the control circuit and accessible by the processor, a coordination application stored in the memory and executable in the processor, and a communication interface operatively connected to the control circuit and configured for communication with one or more computing devices and a plurality of presentation devices affixed to a structure of the restaurant. The coordination application, when executed by the processor, configures the control circuit to load a first display scheme into the memory for depiction on the presentation devices, the first display scheme having one or more coordinated visual arrangements capable of being depicted across the presentation devices to provide a first multimedia experience to the restaurant, and to transmit a first menu scheme to the computing devices, the first menu scheme being correlated to the first display scheme and including one or more food items for selection. The coordination application further configures the control circuit to monitor a first set of revenue drivers at the local machine, the first set of revenue drivers including one or more indicators relating to a revenue calculation for the restaurant and in association with at least one of the first display scheme and the first menu scheme. After a time interval, the coordination application configures the control circuit to substitute a second display scheme for the first display scheme, the second display scheme having one or more coordinated visual arrangements capable of being depicted across the presentation devices to provide a second multimedia experience to the restaurant that is different than the first multimedia experience, and transmit the second menu scheme to the computing devices, the second menu scheme being correlated to the second display scheme and including one or more food items for selection, at least one of which is different than the one or more food items of the first menu scheme. The coordination application further configures the control circuit to monitor a second set of revenue drivers at the local machine, the second set of revenue drivers including one or more indicators relating to a revenue calculation for the restaurant and in association with at least one of the second display scheme and the second menu scheme, compare the first set of revenue drivers with the second set of revenue drivers to determine at least one of an optimal display scheme and an optimal menu scheme for the restaurant, and output at least one of the optimal display scheme and the optimal menu scheme.

These and other aspects, features, and advantages can be appreciated from the accompanying description of certain embodiments of the invention and the accompanying drawing figures.

### BRIEF DESCRIPTION OF THE DRAWINGS

FIG. 1 is a high-level diagram illustrating an exemplary configuration of a dynamic restaurant experience system;

FIG. 2 is a schematic illustration of several of the components of dynamic restaurant experience system arranged within a restaurant;

FIG. 3 is a schematic illustration of several of the components of dynamic restaurant experience system arranged within a restaurant having seating booths;

FIG. 4 is a high level diagram illustrating the arrangement of and relationship between the various components of a dynamic restaurant experience system;

FIG. 5 is a high level diagram illustrating an alternate arrangement of a dynamic restaurant experience system; and

FIG. 6 a flow diagram is described showing a routine that illustrates a broad aspect of a method for deploying one or more dynamic experiences within a restaurant in accordance with one exemplary embodiment.

### DETAILED DESCRIPTION OF CERTAIN EMBODIMENTS OF THE INVENTION

By way of overview and introduction, the present disclosure details systems and methods for deploying one or more dynamic experiences within a restaurant. Existing restaurants and other food establishments traditionally require the establishment of fixed décor within the restaurant space, as well as a menu of dishes that does not change regularly. As a result, profitability can suffer over the long run if prospective diners tire of repeating the same dining experience at every visit. Accordingly, the systems and methods disclosed herein serve to equip restaurant spaces with various presentation devices (including display screens, lighting devices, audio output devices, and odor creation devices) that are in communication with a local machine. The local machine configures the various presentation devices to depict various display schemes (incorporating imagery, sound, lighting, and odor), thereby creating an immersive multimedia experience within the restaurant space. The local machine can further substitute various additional display schemes, thereby providing variable multimedia experiences within the same restaurant space. Menu schemes that are correlated with the various display schemes can be provided to diners at the restaurant through computing devices that are in communication with the local machine. These menu schemes can include various food items and/or item names that can further reflect the theme projected by the various display schemes (e.g., a particular cuisine being correlated with a multimedia experience depicting the sights and sounds of the region from which the particular cuisine originates or a theme-named food item). Like the display schemes, the menu schemes can be substituted at certain intervals, thereby providing variable menu options within a single restaurant.

Throughout the operation of the dynamic restaurant experience system, various revenue drivers are monitored that correspond to particular display schemes and menu schemes employed by the dynamic restaurant experience system. Additionally, the local computer of the dynamic restaurant experience system can be in communication with other dynamic restaurant experience systems deployed in other restaurants, and can receive revenue drivers (corresponding to various display schemes and/or menu schemes) from those systems as well. The various revenue drivers can then be compared and/or processed with one another in order to determine one or more preferred or optimal display schemes and/or menu schemes.

Through the implementation of the methods and systems disclosed herein, a restaurateur is able to rapidly and seamlessly transition between various display and menu schemes, thereby effectively creating entirely new restaurant experiences instantaneously. Thus, for example, a restaurant may implement a first display scheme and a first menu scheme during lunch hours, while implementing an entirely different display scheme and menu scheme during dinner hours. Moreover, using the present systems and methods, the restaurateur can select, track and identify display schemes and/or menu schemes that are likely to generate additional revenue for the restaurant.

The following detailed description is directed to systems and methods for deploying one or more dynamic experiences within a restaurant. The referenced systems and methods are now described more fully with reference to the accompanying drawings, in which one or more illustrated embodiments and/or arrangements of the systems and methods are shown. The systems and methods are not limited in any way to the illustrated embodiments and/or arrangements as the illustrated embodiments and/or arrangements described below are merely exemplary of the systems and methods, which can be embodied in various forms, as appreciated by one skilled in the art. Therefore, it is to be understood that any structural and functional details disclosed herein are not to be interpreted as limiting the systems and methods, but rather are provided as a representative embodiment and/or arrangement for teaching one skilled in the art one or more ways to implement the systems and methods. Accordingly, aspects of the present systems and methods can take the form of an entirely hardware embodiment, an entirely software embodiment (including firmware, resident software, micro-code, etc.) or an embodiment combining software and hardware. One of skill in the art can appreciate that a software process can be transformed into an equivalent hardware structure, and a hardware structure can itself be transformed into an equivalent software process. Thus, the selection of a hardware implementation versus a software implementation is one of design choice and left to the implementer. Furthermore, the terms and phrases used herein are not intended to be limiting, but rather are to provide an understandable description of the systems and methods.

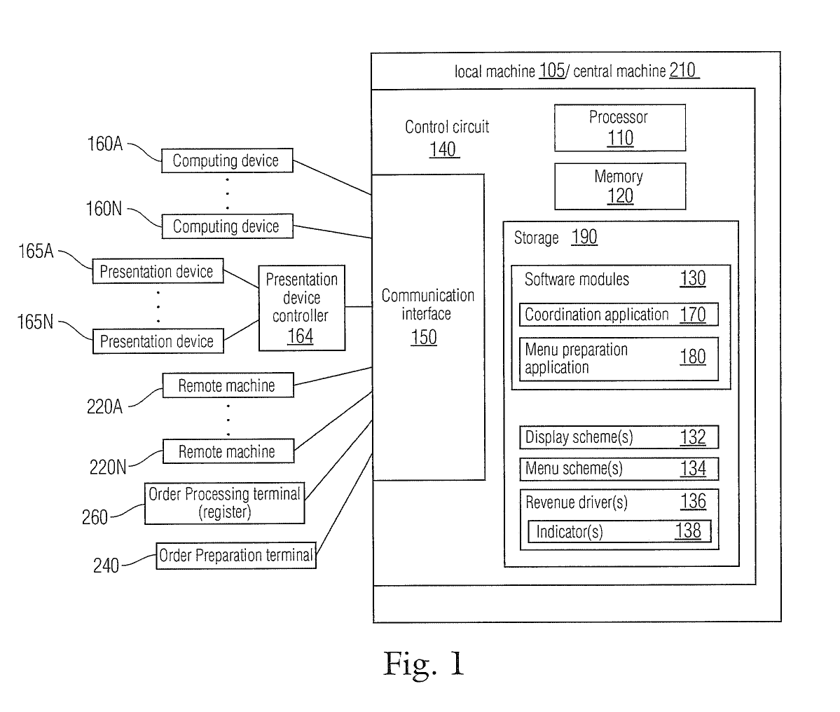

An exemplary computer system is shown as a block diagram in FIG. 1 which is a high-level diagram illustrating an exemplary configuration of a dynamic restaurant experience system 100. In one arrangement, local machine 105 can be a computer such as a personal computer or a server. In another arrangement, local machine 105 can be a plurality of computers in communication with one another, though it should be understood that local machine 105 of dynamic restaurant experience system 100 can be practically any computing device capable of embodying the systems and/or methods described herein.

Local machine 105 of dynamic restaurant experience system 100 includes a control circuit 140 which is operatively connected to various hardware and software components that serve to enable operation of the dynamic restaurant experience system 100. The control circuit 140 is operatively connected to a processor 110 and a memory 120. Processor 110 serves to execute instructions for software that can be loaded into memory 120. Processor 110 can be a number of processors, a multi-processor core, or some other type of processor, depending on the particular implementation. Further, processor 110 can be implemented using a number of heterogeneous processor systems in which a main processor is present with secondary processors on a single chip. As another illustrative example, processor 110 can be a symmetric multi-processor system containing multiple processors of the same type.

Preferably, memory 120 and/or storage 190 are accessible by processor 110, thereby enabling processor 110 to receive and execute instructions stored on memory 120 and/or on storage 190. Memory 120 can be, for example, a random access memory (RAM) or any other suitable volatile or non-volatile computer readable storage medium. In addition, memory 120 can be fixed or removable. Storage 190 can take various forms, depending on the particular implementation. For example, storage 190 can contain one or more components or devices. For example, storage 190 can be a hard drive, a flash memory, a rewritable optical disk, a rewritable magnetic tape, or some combination of the above. Storage 190 also can be fixed or removable. For example, a removable hard drive can be used as storage 190.

One or more software modules 130 are encoded in storage 190 and/or in memory 120. The software modules 130 can comprise one or more software programs or applications having computer program code or a set of instructions executed in processor 110. Such computer program code or instructions for carrying out operations for aspects of the systems and methods disclosed herein can be written in any combination of one or more programming languages, including an object oriented programming language such as Java, Smalltalk, C++ or the like and conventional procedural programming languages, such as the “C” programming language or similar programming languages. The program code can execute entirely on the local machine 105, partly on local machine 105, as a stand-alone software package, partly on local machine 105 and partly on a remote computer or entirely on the remote computer or server. In the latter scenario, the remote computer can be connected to local machine 105 through any type of network, including a local area network (LAN) or a wide area network (WAN), or the connection can be made to an external computer (for example, through the Internet using an Internet Service Provider).

Software modules 130, including program code/instructions, are located in a functional form on one or more computer readable storage devices (such as memory 120 and/or storage 190) that can be selectively removable. The software modules 130 can be loaded onto or transferred to local machine 105 for execution by processor 110. It can also be said that the program code of software modules 130 and one or more computer readable storage devices (such as memory 120 and/or storage 190) form a computer program product.

It should be understood that in some illustrative embodiments, one or more of software modules 130 can be downloaded over a network to storage 190 from another device or system via communication interface 150 for use within dynamic restaurant experience system 100. For instance, program code stored in a computer readable storage device in a server can be downloaded over a network from the server to dynamic restaurant experience system 100.

Preferably, included among the software modules 130 is a coordination application 170 that is executed by processor 110. During execution of the software modules 130, and specifically the coordination application 170, the processor 110 configures the control circuit 140 to deploy one or more dynamic experiences within a restaurant, as will be described in greater detail below. It should be noted that while FIG. 1 depicts memory 120 oriented on control circuit 140, in an alternate arrangement, memory 120 can be operatively connected to the control circuit 140. It should also be noted that other software modules (such as menu preparation application 180) and other information and/or data relevant to the operation of the present systems and methods (such as display schemes 132, menu schemes 134, and revenue drivers 136) can also be stored on storage 190, as will be discussed in greater detail below.

A communication interface 150 is also operatively connected to control circuit 140. Communication interface 150 can be any interface that enables communication between the local machine 105 and external devices, machines and/or elements. Preferably, communication interface 150 includes, but is not limited to, a modem, a Network Interface Card (NIC), an integrated network interface, a radio frequency transmitter/receiver, an infrared port, a USB connection, or any other such interfaces for connecting local machine 105 to other computing devices. Such connections can include a wired connection or a wireless connection (e.g. 802.11) though it should be understood that communication interface 150 can be practically any interface that enables communication to/from the control circuit 140.

At various points during the operation of dynamic restaurant experience system 100, local machine 105 can communicate with one or more computing devices 160A-N (collectively computing devices 160). The computing devices 160 transmit and/or receive data to/from the local machine 105, preferably in furtherance of a menu scheme and/or to facilitate food item selection, as will be described in greater detail below. While computing device 160 can be practically any device capable of communication with local machine 105, in the preferred embodiment computing device 160 is a handheld/portable computer, smartphone, personal digital assistant (PDA), tablet computer (such as an iPad, manufactured by Apple, Inc. of Cupertino, Calif.) and/or any portable device that is capable of transmitting and receiving data to/from local machine 105. The user of computing device 160 preferably interacts with local machine 105 through an application (‘app’) executing on the user's computing device 160. This application provides a simple and intuitive user interface that enables the user to receive, review, and input data, information, and/or settings that relate to the operation of the dynamic restaurant experience system 100, as will be described in greater detail below. In an alternate arrangement, the user can communicate with dynamic restaurant experience system 100 through a website and/or a web-based interface. In such an arrangement, the user need not execute the referenced application on computing device 160, rather the referenced website enables substantially the same functionality through a web-interface.

It should be noted that while the FIG. 1 depicts the dynamic restaurant experience system 100 with respect to computing device 160A and computing device 160N (generically, computing devices 160), it should be understood that any number of computing devices can interact with dynamic restaurant experience system 100 in the manner described herein.

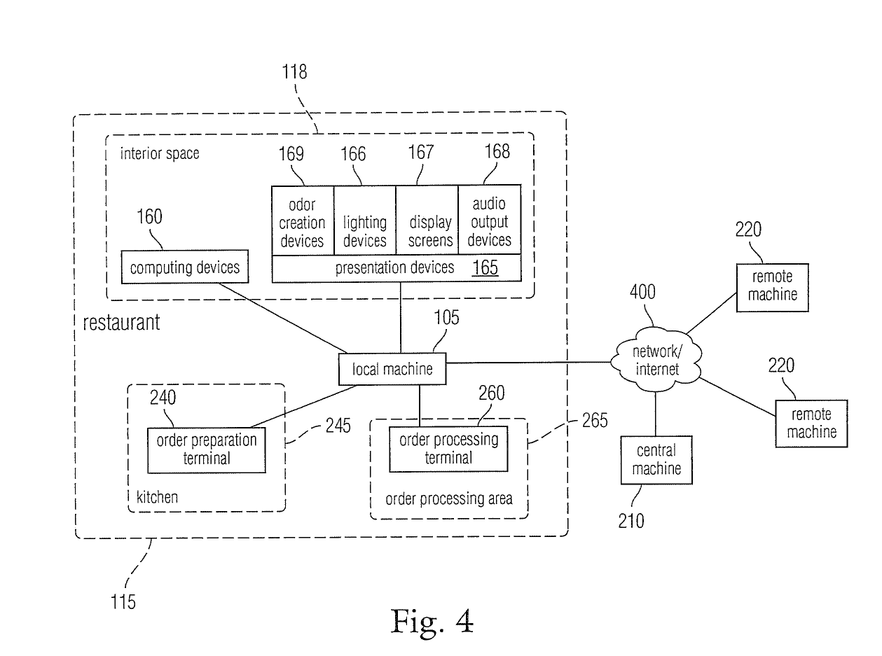

Also preferably connected to and/or in communication with local machine 105 is a presentation device controller 164, such as a video display controller (VDC). Presentation device controller 164 is preferably connected to and/or in communication with one or more presentation devices 165A-165N (generically presentation devices 165). Generally, presentation devices 165 are various types of devices that can contribute to creating a dynamic multimedia experience within an enclosed space, such as a restaurant or restaurant booth. Examples of such presentation devices 165 include lighting devices 166 (such as LED lights), display screens 167 (such as LCD or plasma monitors or televisions), audio output devices 168 (such as speakers), and/or odor creation devices and/or systems (such as a ‘Smell-O-Vision’ device) as shown in FIG. 4. Thus, presentation device controller 164 effectively coordinates the delivery of various multimedia experiences (including light, display, sound, and odor) to the various presentation devices 165 as will be described in greater detail below. However, it should be noted that while FIG. 1 depicts presentation devices 165 as being connected to and/or in communication with local machine 105 through presentation device controller 164, it should be understood that in certain arrangements one or more of presentation devices can be connected to and/or in communication with local machine 105 directly (that is, without the presentation device controller 164 implemented in between). Additionally, as will be described in greater detail below, local machine 105 can preferably communicate with one or more presentation devices 165 within a restaurant space in order to create a dynamic multimedia experience within the space.

At this juncture, it should be noted that in certain arrangements, certain of computing devices 160 can be configured to and/or in communication with one or more presentation devices 165, preferably through communication interface 150. Thus, for example, computing device 160A can be configured to control or otherwise interact with presentation device 165A, while computing device 160N can be similarly configured with respect to presentation device 165N. It can be appreciated that such an arrangement enables further customization and a further dynamic experience across the various computing devices 160 and presentation devices 165, in accordance with the various functions and operations described herein.

In certain arrangements, one or more remote machines 220A-220N (generically remote machines 220) are also in communication with local machine 105. As will be described in greater detail below, remote machines 220 can have a similar, if not identical structure and/or operation to local machine 105, however the remote machines 220 are deployed in remote locations, such as in restaurants in other geographic areas. In communicating with remote machines 220, local machine 105 can leverage data generated at remote machines 220 in order to improve its own performance, as will be described in greater detail below.

Also preferably in communication with local machine 105 is order processing terminal 260. Order processing terminal 260 is preferably a point of sale (POS) terminal such as a cash register or a computer (such as local machine 105) running POS software that can generate revenue information relating to the operations of a restaurant or other such establishment. In communicating with the order processing terminal 260, local machine 105 can receive/process revenue related information to determine preferred and/or optimal presentation and/or menu schemes for the restaurant, as will be described in greater detail below.

In certain arrangements, an order preparation terminal 240 is also in communication with local machine 105. Order preparation terminal is preferably a computing device and/or system that coordinates and/or assists in the preparation of food orders at a restaurant. As will be described in greater detail below, an order preparation terminal can present a food order to a chef in the restaurant's kitchen, optionally together with instructions and/or directions as to how to prepare the respective food items in the order. In communicating with order preparation terminal 240, local machine 105 can provide appropriate order preparation instructions to order preparation terminal 240, and such instructions can vary or change over time, depending on the menu scheme being implemented at a given time.

In the description that follows, certain embodiments and/or arrangements are described with reference to acts and symbolic representations of operations that are performed by one or more devices, such as the dynamic restaurant experience system 100 of FIG. 1. As such, it will be understood that such acts and operations, which are at times referred to as being computer-executed, include the manipulation by the processor of the computer of electrical signals representing data in a structured form. This manipulation transforms the data and/or maintains them at locations in the memory system of the computer, which reconfigures and/or otherwise alters the operation of the computer in a manner understood by those skilled in the art. The data structures in which data is maintained are physical locations of the memory that have particular properties defined by the format of the data. However, while an embodiment is being described in the foregoing context, it is not meant to provide architectural limitations to the manner in which different embodiments can be implemented. The different illustrative embodiments can be implemented in a system including components in addition to or in place of those illustrated for the dynamic restaurant experience system 100. Other components shown in FIG. 1 can be varied from the illustrative examples shown. The different embodiments can be implemented using any hardware device or system capable of running program code. In another illustrative example, dynamic restaurant experience system 100 can take the form of a hardware unit that has circuits that are manufactured or configured for a particular use. This type of hardware can perform operations without needing program code to be loaded into a memory from a computer readable storage device to be configured to perform the operations.

For example, local machine 105 can take the form of a circuit system, an application specific integrated circuit (ASIC), a programmable logic device, or some other suitable type of hardware configured to perform a number of operations. With a programmable logic device, the device is configured to perform the number of operations. The device can be reconfigured at a later time or can be permanently configured to perform the number of operations. Examples of programmable logic devices include, for example, a programmable logic array, programmable array logic, a field programmable logic array, a field programmable gate array, and other suitable hardware devices. With this type of implementation, software modules 130 can be omitted because the processes for the different embodiments are implemented in a hardware unit.

In still another illustrative example, local machine 105 can be implemented using a combination of processors found in computers and hardware units. Processor 110 can have a number of hardware units and a number of processors that are configured to execute software modules 130. With this depicted example, some of the processors can be implemented in the number of hardware units, while other processors can be implemented in the number of processors.

In another example, a bus system can be implemented and can be comprised of one or more buses, such as a system bus or an input/output bus. Of course, the bus system may be implemented using any suitable type of architecture that provides for a transfer of data between different components or devices attached to the bus system. Additionally, communication interface 150 can include one or more devices used to transmit and receive data, such as a modem or a network adapter.

Embodiments and/or arrangements can be described in a general context of computer-executable instructions, such as program modules, being executed by a computer. Generally, program modules include routines, programs, objects, components, data structures, etc., that perform particular tasks or implement particular abstract data types.

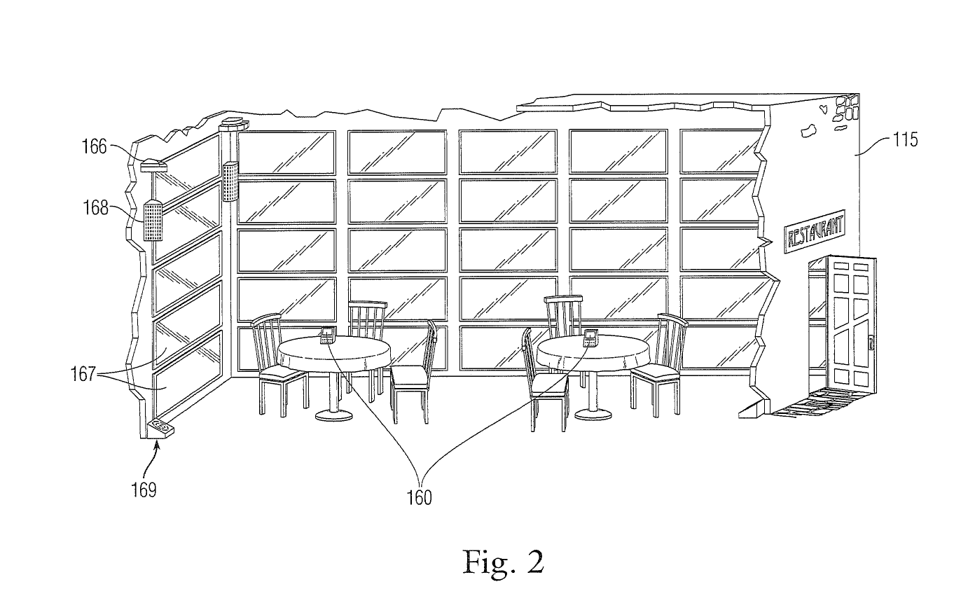

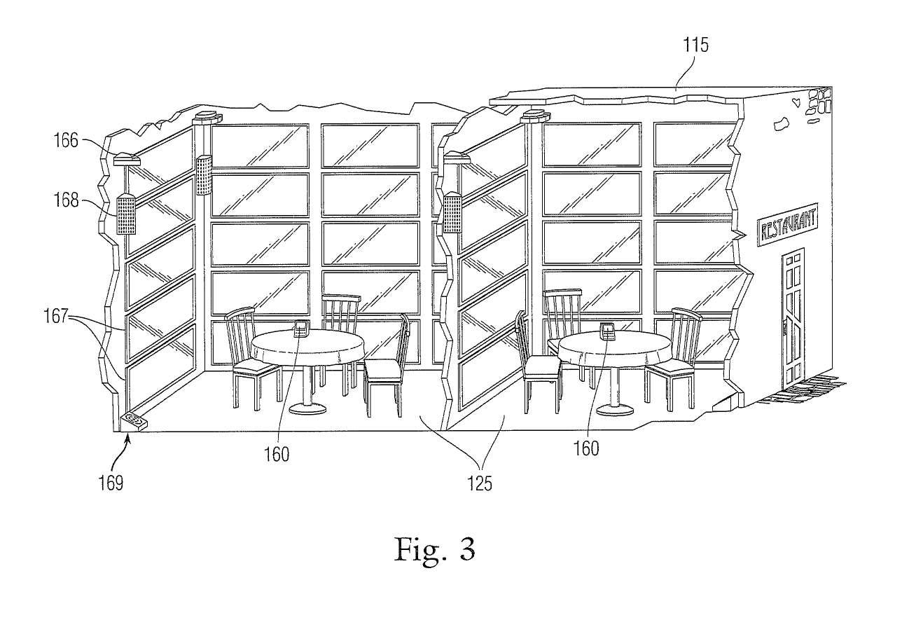

The arrangement of several of the various components of dynamic restaurant experience system 100 within a restaurant space can be appreciated with reference to FIGS. 2 and 3.

FIG. 2 depicts a schematic illustration of several of the components of dynamic restaurant experience system 100 arranged within a restaurant 115. One or more presentation devices 165, such as display screens 167 are preferably affixed to the interior spaces 118 (e.g., the walls) of restaurant 115. While FIG. 2 depicts the various walls of restaurant 115 as being covered with display screens 167, it should be understood that practically any interior surface 118 of restaurant 115, such as the floors and/or ceiling can be covered with display screens 167. As will be described in greater detail below, the display screens 167 serve to display one or more coordinated visual arrangements as part of a display scheme, thereby providing a dynamic multimedia experience to diners at the restaurant. It should be noted that the operation of display screens 167 is preferably coordinated by local machine 105 executing coordination application 170, as will be described in greater detail below.

Also preferably configured within the interior space 118 of the restaurant 115 are lighting devices 166. Lighting devices 166 can be practically any form of lighting, including but not limited to LED, halogen, florescent, and incandescent lighting devices. Preferably, lighting devices 166 are adjustable such that various lighting configurations (such as adjustments to the intensity, color, and/or arrangement of the individual or collective lighting devices 166) can be implemented throughout the presentation of one or more display schemes, as will be described in greater detail below. It should be understood that lighting devices can be arranged in practically any area and/or configuration within interior space 118 of restaurant 115. It should also be understood that the various configurations and/or adjustments made to the operation of lighting devices 166 are preferably coordinated by local machine 105 executing coordination application 170, as will be described in greater detail below.

Audio output devices 168 are also preferably implemented within the interior space 118 of restaurant 115. As noted above, audio output devices 168 are preferably speakers or any other such device or group of devices capable of projecting audio signals within a space. Audio output devices 168 can be arranged in practically any location within the interior space 118 of restaurant 115, and they serve to project audio signals, such as ambient music and/or noise in furtherance of a multimedia experience being provided to the diners of restaurant 115. As will be described in greater detail below, the music projected by audio output devices 168 is preferably configured by local machine 105, and can be adjusted and/or changed over time, thereby providing a dynamic multimedia experience, as will be described in greater detail below.

In certain arrangements, odor creation devices 169 are also preferably implemented within the interior space 118 of restaurant 115. As noted above, odor creation devices 169 are preferably a ‘Smell-O-Vision’-type device that is capable of generating one or more odors on command, and/or distributing such odors throughout a space, such as through the use of fans or any other such ventilation system. Examples of such a device can be found in U.S. Pat. No. 7,011,795 to Thompson, et al. and U.S. Pat. No. 6,152,829 to Jaidka, each of which are incorporated by reference herein in their respective entireties. Odor creation devices 168 can be arranged in practically any location within the interior space 118 of restaurant 115, and they serve to project odors, such as smells of a particular area (such as the salt-water smell of a beach) in furtherance of a multimedia experience being provided to the diners of restaurant 115. As will be described in greater detail below, the odors projected by odor creation devices 169 are preferably configured by local machine 105, and can be adjusted and/or changed over time, thereby providing a dynamic multimedia experience, as will be described in greater detail below.

Also preferably deployed within interior space 118 of restaurant 115 are one or more computing devices 160. In certain arrangements, computing devices 160 can be tablet computers such as iPads, while in other arrangements computing devices 160 can be smartphones or portable devices such as iPhones or iPods manufactured by Apple, Inc. of Cupertino, Calif. Irrespective of the particular arrangement, computing devices 160 are preferably in communication with local machine 105, and each computing device 160 preferably executes with an on-board processor an application or ‘app’ comprising code or code modules that enable a user to select one or more food items from a menu provided by local machine 105. The computing devices 160 are preferably distributed at each table, though it should be understood that if devices such as smartphones are utilized, such devices may be provided by the diner, and thus no prior distribution will be necessary. As will be described in greater detail below, the menu displayed by computing device 160 can change over time (in response to changes in the menu scheme of the dynamic restaurant experience system 100, and/or in response to filters imposed by a user, such as diet filters), and selections from the menu can further impact the arrangements depicted by presentation devices 165, as will be described in greater detail below.

While FIG. 2 depicts a the dynamic restaurant experience system 100 as arranged within a conventional restaurant (wherein the diners are seated at tables distributed within the interior space 118 of the restaurant 115), FIG. 3 depicts an alternative arrangement wherein respective sets of diners are seated in individual dining areas or booths 125 that are enclosed within restaurant 115. It can be appreciated that the various components depicted in FIG. 3, such as lighting devices 166, display screens 167, audio output devices 168, odor creation devices 169, and computing devices 160 can be arranged and/or distributed in a substantially similar manner as that depicted in FIG. 2. However, the individual booths 125 of the arrangement in FIG. 3 enable each individual set of diners (seated at a given table) to select and/or experience a different multimedia presentation, as will be described in greater detail below.

FIG. 4 depicts a high level diagram illustrating the arrangement of and relationship between the various components of dynamic restaurant experience system 100. As has been already discussed, local machine 105 is preferably in communication with each of the various components at various points during the operation of dynamic restaurant experience system 100. While in most arrangements local machine 105 will be physically deployed within the space of restaurant 115, it should be understood that in other arrangements local machine 105 can be deployed elsewhere, such as in a remote location or in a cloud-based configuration.

As referenced above, computing devices 160 and presentation devices 165 (including lighting devices 166, display screens 167, audio output devices 168, and odor creation devices 169) are preferably in communication with local machine 105 and are deployed within the interior space 118 of restaurant 115. These various devices serve to enable the various display schemes and menu schemes of the dynamic restaurant experience system 100 within the restaurant's interior space 118, as will be described in greater detail below.

Also in communication with local machine 105 is order preparation terminal 240. As referenced above, order preparation terminal 240 can provide food preparation instructions that correspond to food items selected from a menu. As such, order preparation terminal 240 is preferably configured within the kitchen 245 of restaurant 115.

Order processing terminal 260 is preferably a POS terminal that is arranged in an order processing area 265 of restaurant 115, such as at a checkout desk or area. As referenced above, order processing terminal 260 provides revenue drivers and indicators to local machine 105, enabling local machine 105 to determine preferred and/or optimal display and/or menu schemes, as will be described in greater detail below.

In certain arrangements, local machine 105 is also preferably connected, such as through a network and/or Internet connection 400, to receive information, directly or indirectly, from one or more remote machines 220. As discussed above, remote machines 220 are preferably computers and/or computing devices deployed at remote locations (such as in geographical areas different from that of local machine 105) having substantially similar functions and capabilities as local machine 105. In communicating with remote machines 220, local machine 105 can receive revenue-related feedback and data pertaining to various display and/or menu schemes deployed using such remote machines 220 at remote restaurants 115. In doing so, local machine 105 can process the data received, directly or indirectly, from remote machines 220 in order to further determine optimal and/or preferred display schemes and/or menu schemes. In certain arrangements, these determined schemes can in turn be made available to and/or transmitted to one or more of the remote machines 220. The local machine 105 and remote machine 220 can be in communication with a central machine 210, as discussed next.

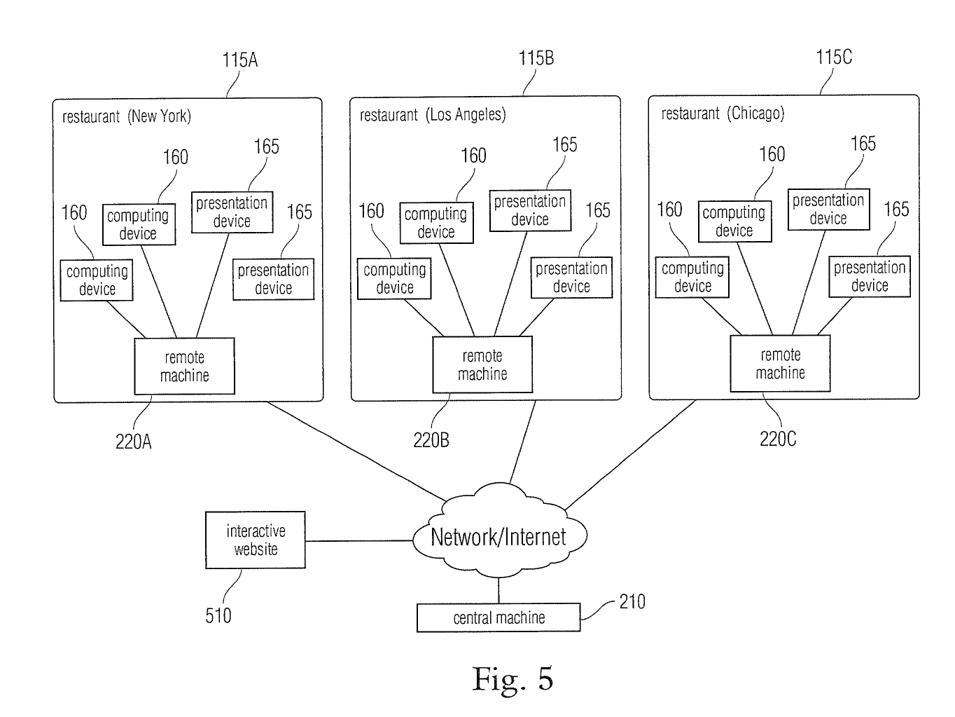

FIG. 5 depicts a high level diagram illustrating an alternate arrangement of dynamic restaurant experience system 100. While the arrangements described above, such as with respect to FIG. 4, focus primarily on a local machine 105 that coordinates the deployment of dynamic multimedia experiences within a single restaurant 115, the arrangement depicted in FIG. 5 depicts a centralized arrangement wherein a central machine 210 manages and/or coordinates such dynamic experiences across any number of remote machines 220. It should be understood that the architecture, arrangement, and operation of both central machine 210 and remote machines 220 can be substantially similar to that of local machine 105 referenced above and depicted in FIG. 1. One distinction between the central machine 210 and remote machines 220A-C (generically remote machines 220) depicted in FIG. 5 is that central machine is configured primarily to receive information pertaining to various display schemes and menu schemes from the various remote machines 220 (including local machine 105), process the information, and transmit further information back to machines 105, 220, while the machines 105, 220 themselves are directed to deploying dynamic multimedia experiences within their respective restaurants 115A-C (generically restaurants 115) through interaction and communication with computing devices 160 and presentation devices 165. Another distinction is that the central machine 210 can provide dynamic environments as a service to the machines 105, 220, such as a subscription service. Central machine 210 preferably communicates with remote machines 220 through a computer network 400 such as the Internet. In doing so, central machine 210 can harness the data generated by each of the respective restaurants 115 (such as restaurant 115A located in New York, and restaurant 115B located in Los Angeles) to provide further insight to the operator of dynamic restaurant experience system 100 and/or to the operators of remote machines 220 as to how to best configure various of the remote machines (particularly the presentation devices 165 configured by the remote machines 220) in order to create an appealing dining environment and experience and to maximize the revenue of the particular restaurant 115.

An interactive website 510 that is accessible to any number of users is also preferably in communication with remote machines 220 and/or central machine 210 through a communications network such as the Internet 400, as depicted in FIG. 5. Interactive website 510 can provide users with real-time information from remote machines 220, such as current and upcoming multimedia experiences (e.g., French night, Chinese night, etc.) that will be employed at the various restaurants 115. In doing so, various restaurants can notify potential customers of upcoming experiences, while the various remote machines 220 and central machine 210 can gauge customer interest in other schemes through the use of surveys and submission forms which enable diners to indicate their preferences for future restaurant experiences. This data can in turn be used to plan future restaurant experience schemes and/or theme nights.

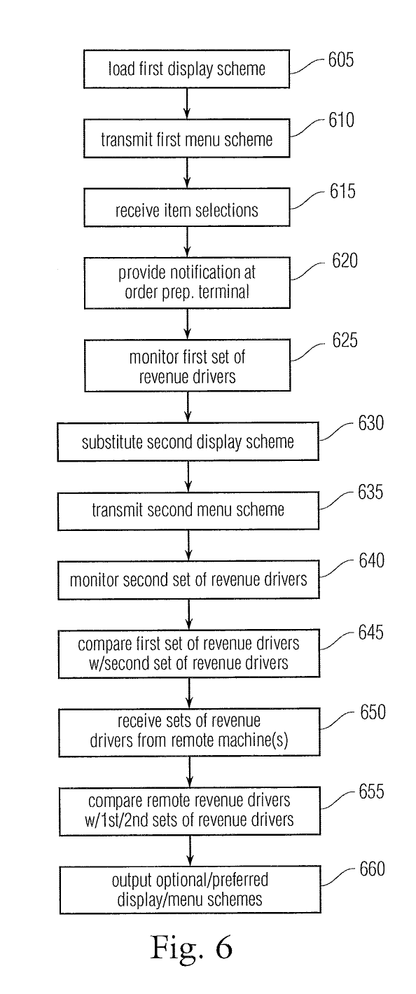

The operation of the dynamic restaurant experience system 100 and the various elements described above will be further appreciated with reference to the method for deploying one or more dynamic experiences within a restaurant as described below, in conjunction with FIG. 6.

Turning now to FIG. 6, a flow diagram is described showing a routine 600 that illustrates a broad aspect of a method for deploying one or more dynamic experiences within a restaurant in accordance with at least one embodiment disclosed herein. It should be appreciated that several of the logical operations described herein are implemented (1) as a sequence of computer implemented acts or program modules running on dynamic restaurant experience system 100 and/or (2) as interconnected machine logic circuits or circuit modules within the dynamic restaurant experience system 100. The implementation is a matter of choice dependent on the requirements of the device (e.g., size, energy, consumption, performance, etc.). Accordingly, the logical operations described herein are referred to variously as operations, structural devices, acts, or modules. Various of these operations, structural devices, acts and modules can be implemented in software, in firmware, in special purpose digital logic, and any combination thereof. It should also be appreciated that more or fewer operations can be performed than shown in the figures and described herein. These operations can also be performed in a different order than those described herein.

The process begins at step 605 where the local machine 105 loads a first display scheme 132 into memory 120. As depicted in FIG. 1, display schemes 132 are preferably stored on storage 190, and can be loaded into memory 120 during or in conjunction with the execution of coordination application 170 at processor 110. Display schemes 132 are preferably data files or sets of data files that include one or more coordinated visual arrangements that are capable of being depicted across the presentation devices 165. By way of example, display schemes 132 can include one or more high-resolution images and/or videos that can be displayed on display screens 167 in order to create certain visual experiences for a diner at restaurant 115. Preferably, the various images and/or videos included in a given display scheme 132 are coordinated such that the display scheme 132 utilizes the arrangement of the presentation devices 165 (such as display screens 167) to create an engaging visual experience for a diner at the restaurant 115. For example, display scheme 132 can dictate that one set of images or videos are to be displayed on one or more monitors on one wall of the restaurant 115 (such as the north-facing wall) while another set of images or videos are to be displayed on one or more monitors on another wall of the restaurant 115 (such as the east-facing wall), thereby simulating an experience of dining in a location having distinctive views at various directions (for example, at the top of the Empire State Building).

Also preferably included within display scheme 132 are data and/or instructions that pertain to the operation of lighting devices 166, audio output devices 168, and odor creation devices 169. By way of example, display scheme 132 can dictate that the various lighting devices at a given restaurant 115 should be adjusted to project a certain type of lighting or atmosphere within the restaurant 115, such as simulating a beachside café (by projecting bright lighting) or a sunset (by gradually dimming the lighting over time).

Additionally, instructions pertaining to the operation of audio output devices 168 (such as speakers) are also included within display scheme 132. Such instructions preferably include audio or music tracks or files such as ambient music that, when played, provide a particular audio experience within the restaurant. For example, an audio track can be included that creates an audio environment of a sidewalk café in Paris, or an audio experience of waves crashing against a shore.

It should be understood that the various instructions contained within display scheme 132 (including visual arrangements, lighting instructions, audio instructions, and odor production instructions) are preferably coordinated such that the various instructions complement one another in creating a consistent and coherent multimedia experience within the restaurant 115. For example, a visual arrangement (to be depicted on display screens 167) comprising one or more videos of a beach-side sunset can be complemented by lighting instructions that direct the lighting devices 166 to dim over time, in conjunction with the setting of the sun in the visual arrangement. Complementary audio instructions can further be included, such as a track of waves crashing against a shoreline, as well as complementary odors such as the smell of salt-water.

At step 610, the local machine 105 transmits, and one or more of the computing devices 160 receives a first menu scheme 134. The menu scheme 134 is preferably stored in storage 190, as depicted in FIG. 1. Menu scheme 134 preferably includes one or more food items that comprise a menu, from which a diner can select, preferably using computing device 160. As noted above, in certain arrangements computing devices 160 can be a tablet computer provided at restaurant 115, while in other arrangements computing device 160 can be a smartphone or portable device provided by a diner. In any event, computing device 160 is preferably in communication with local machine 105 in order to receive from and/or transmit to it information regarding one or more food item selections. Preferably, the menu scheme 134 presented to a diner is correlated to or otherwise coordinated with the display scheme 132 being depicted within the restaurant 115 at a given time. By way of example, a menu scheme 134 having French cuisine can be correlated to a display scheme 132 that depicts a scene of a sidewalk café in Paris. In implementing the referenced display scheme 132 and menu scheme 134, the dynamic restaurant experience system 100 can create a complete restaurant multimedia experience that reflects a particular theme.

At this juncture, it should be noted that the menu scheme 134, when presented at computing device 160, can be interacted with by a diner in any number of ways in order to enhance the diner's ability to review and select items from the menu. By way of example and not limitation, the menu scheme (as presented at computing device 160) can be sorted such that menu items that a particular diner is allergic or averse to are filtered out of the menu scheme (as presented at the specific computing device 160). By way of further example only, menu items that fit a particular interest of a given diner (e.g., spicy dishes, and/or dishes that comply or conform to one or more diet restrictions/requirements, such as low-carbohydrate, low-fat, sugar-free, etc. diets) can be similarly filtered for. Additionally, a tracking module (stored among software modules 130) can be implemented to track a particular diner's likes, dislikes, etc., (such as by enabling the user to create a user account that is stored at storage 190 for reference during subsequent restaurant visits), and at subsequent visits the menu scheme 134 presented to the particular diner at computing device 160 can immediately apply any necessary filters, and/or provide recommendations and/or ‘favorite’ dishes (corresponding to dishes that the diner has ordered during previous visits). Additionally, such tracking information can preferably be accessible to remote machines 220 such that if a diner visits a restaurant in a remote location (e.g., restaurant 115B in Los Angeles, as depicted in FIG. 5), the dynamic restaurant experience system 100 implemented at the remote location can immediately provide a customized menu scheme, reflecting the given diner's previously known preferences. In certain arrangements, such preferences can be further supplemented and/or tracked by incorporating a diner's social networking profile (e.g., a Facebook profile).

Then, at step 615, the computing device 160 transmits and the local machine 105 receives one or more item selections from among the food items in menu scheme 134. These selections are preferably selected from the menu by one or more diners. In certain arrangements, the various item selections that make up a given menu scheme can comprise at least one base ingredient and one or more particular preparation instructions and/or supplemental ingredients. By way of example, chicken can be one base ingredient included in the menu scheme 134, and an accompanying preparation instruction can be to fry the chicken, or to stuff the chicken with vegetables. The preparation instructions are preferably correlated to a menu scheme 134. In doing so, the restaurant 115 can change the menu scheme 134 at various intervals, such that the various base ingredients (e.g., chicken, beef, potatoes) remain constant across the various menu schemes 134, while the particular preparation instructions and/or supplemental ingredients can change from scheme to scheme. In doing so, the dynamic restaurant experience system 100 ensures that despite the variations across the various menu schemes, certain fundamental base ingredients remain constant, thereby enabling a smooth transition for the restaurant's 115 food preparation staff from one menu scheme to another, as will be described in greater detail below.

At step 620, one or more notifications are provided from local computer 105 to order preparation terminal 240. The notifications are preferably generated by menu preparation application 180, and they preferably correspond to the item selections made at step 615. The notifications reflect at least the one base ingredient and the one or more particular preparation instructions and/or supplemental ingredients corresponding to the selections, as referenced above. In doing so, restaurant staff (e.g., chefs) working in the kitchen 245 of restaurant 115 can quickly review an incoming order and identify the base ingredient (which will generally be found in food items across various menu schemes) and the particular preparation instructions and/or supplemental ingredients (which can vary across menu schemes) in order to prepare the selected food item.

At step 625, the local machine 105 monitors at least a first set of revenue drivers 136. Revenue drivers 136 preferably include one or more indicators 138 that relate and/or contribute to a revenue calculation for restaurant 115. The indicators 138 that make up revenue drivers 136 can include data generated by order processing terminal 260, such as the various food items ordered, each item's respective price, the amount provided by the diners as a tip, or any other indicator 138 relating to the revenue generated by the restaurant. These indicators 138 can also be associated with the display scheme 132 and/or the menu scheme 134 that is employed by dynamic restaurant experience system 100 during the time that the particular food items were ordered. In doing so, the dynamic restaurant experience system 100 can assess how the various display schemes 132 and menu schemes 134 affect the revenue drivers 136, and the overall revenue of the restaurant 115, as will be described in greater detail below.

Then, at step 630, the local machine 105 preferably substitutes a second display scheme for the first display scheme. This step is substantially similar to step 605, except that here a second display scheme is being substituted for a first display scheme that was previously implemented in dynamic restaurant experience system 100. By way of example, a restaurant 115 can implement a first display scheme during lunch hours (e.g., 12 pm-5 pm) and a second display scheme during dinner hours (e.g., 5 pm-10 pm). In doing so, the dynamic restaurant experience system 100 can provide a number of restaurant experiences to diners at a single restaurant 115 over the course of a single day.

Generally, the substitution of a second display scheme for a first display scheme can occur after a time interval, such as in the example of changing display schemes between lunch and dinner hours. However, in certain arrangements a second display scheme can be substituted for a first display scheme in response to a particular event or input. By way of example, a diner seated at a booth 125 within restaurant 115 can be presented with a menu scheme 134 at computing device 160 that includes food items from a number of diverse cuisines (e.g., French, Chinese, Mexican, etc.). Upon selecting items from a particular cuisine (e.g., Chinese), local machine 105 can substitute a display scheme that is correlated with the selected items (e.g., images, videos, lighting, audio, etc., that depict a Chinese atmosphere or scene) for the display scheme that was initially deployed within the booth 125. In addition, in certain arrangements local machine 105 can substitute a second, temporary, display scheme for a first display scheme. By way of example, if a group has gathered in a dining booth 125 to celebrate an individual's birthday, at a certain point during the meal (e.g., when a birthday cake is brought to the booth 125) the local machine 105 can substitute a birthday-related display scheme (e.g., a visual depiction of candles, fireworks, photos from the individual's life, the audio of the song ‘Happy Birthday’) for the first display scheme. Subsequently, local machine 105 can revert the respective presentation devices 165 back to the first display scheme.

In conjunction with the substitution of a second display scheme for a first display scheme, at step 635 a second menu scheme optionally can be transmitted to computing devices 160. The operation of local machine 105 in transmitting the second menu scheme to the computing devices 160 is substantially similar to the transmitting of the first menu scheme at step 610, except that here a first menu scheme is being substituted by a second menu scheme. It should be noted that the second menu scheme is preferably correlated to the second display scheme referenced above.

Then, at step 640, the local machine 105 monitors a second set of revenue drivers. The operation of local machine 105 in monitoring the second set of revenue drivers is substantially similar to the monitoring of the first set of revenue drivers at step 625, except that here a second set of revenue drives are being monitored by local machine 105. As referenced above, the second set of revenue drivers includes indicators that relate and/or contribute to a revenue calculation for restaurant 115. By monitoring the second set of revenue drivers, the dynamic restaurant experience system 100 can assess how the various display schemes 132 and menu schemes 134 affect the revenue drivers 136, and the overall revenue of the restaurant 115.

At step 645, the first set of revenue drivers (monitored at step 625) and the second set of revenue drivers (monitored at step 640) are compared with one another by the local machine 105 executing coordination application 170. Being that the first set of revenue drivers is preferably associated with a first display scheme and/or a first menu scheme, and that the second set of revenue drives is preferably associated with a second display scheme and/or a second menu scheme, by comparing the first and second revenue drivers the coordination application 170 executing at local machine 105 can identify which display schemes and/or menu schemes serve to generate more revenue for the restaurant. Additionally, by comparing the first and second sets of revenue drivers, the coordination application 170 can further identify which aspects of the display schemes and/or menu schemes actually contribute to increases (or decreases) in revenue for the restaurant, and which aspects do not.

By way of example, on one night, the dynamic restaurant experience system 100 can deploy a first display scheme and menu scheme that provide a French multimedia experience and an accompanying menu of French cuisine, while on a second night the dynamic restaurant experience system 100 can deploy a second display scheme and menu scheme that provide a Chinese multimedia experience and an accompanying menu of Chinese cuisine. By comparing the revenue drivers from the French night with the revenue drivers from the Chinese night, the dynamic restaurant experience system 100 can determine which display and/or menu scheme is preferable from a revenue generation standpoint. In an alternate arrangement, the dynamic restaurant experience system 100 can deploy a first display scheme and menu scheme that provide a first French multimedia experience and an accompanying first menu of French cuisine, while on a second night the dynamic restaurant experience system 100 can deploy a second French multimedia experience and an accompanying second menu of French cuisine. By comparing the revenue drivers from the first French night with the revenue drivers from the second French night, the dynamic restaurant experience system 100 can determine which French scheme is preferable from a revenue generation standpoint.

By way of further example, among the indicators 138 included within the revenue drivers 136 can be various metrics that demonstrate a diner's enjoyment of the surroundings and/or atmosphere provided by a restaurant. Among such indicators can be the average length of time spent dining in the restaurant, and the percentage of diners who order dessert, coffee, tea, etc., at the conclusion of their meal. By calculating the average length of time diners spent dining in the restaurant across various display schemes, and comparing the various computed averages, coordination application 170 can transform the collected data into a statistical metric usable to determine which display schemes are potentially more appealing to diners than others. If diners, on average, spend more time dining at a restaurant employing a particular display scheme, it can be reasonably concluded that this display scheme is appealing to diners and provides an enjoyable atmosphere which the diners wish to enjoy for as long as possible. Similar insight can be gleaned from the consideration of the number of diners that order menu items after concluding their meal (e.g., dessert, coffee, etc.). If a display scheme is appealing to a diner, it is more likely that the diner will desire to remain at the restaurant 115 for as long as possible. One way of achieving this is by ordering additional menu items after concluding the meal. Accordingly, by considering these (and other) indicators 138, local machine 105 can determine an optimal display scheme for restaurant 115.

In view of the above examples, it can be appreciated that local machine 105, during the course of step 645, processes the various revenue drivers 136 and/or indicators 138, and ascribes a weighting to each. The weighting is reflective of the value and/or importance that is ascribed to a particular revenue driver 136 and/or indicator 138 (such as its importance to the revenue calculation of the restaurant as a whole). Then, the various revenue drivers 136 and/or indicators 138, together with their respective weightings, are combined with one another to project one or more expected revenue increases (e.g., combining two revenue drivers to determine a projected revenue increase that is likely to result from implementing or targeting the schemes and/or characteristics associated with the combined revenue drivers) and/or are compared with one another (e.g., comparing one revenue driver and its associated weighting with another revenue driver and its associated weighting in order to determine which revenue driver can be expected to generate more revenue). In comparing and/or combining the various revenue drivers 136, indicators 138 and/or their respective weightings, local machine 105, in conjunction with coordination application 170, transforms the referenced data into a metric that can be output and utilized in determining one or more optimal/preferred schemes.

As a further illustration, other indicators that can be included within the revenue drivers 136 can be various metrics that demonstrate a diner's interest in and/or enjoyment of a given menu scheme 134. Among such indicators 138 can be the average price per item or per order, and the frequency with which a previously ordered item is re-ordered over the course of a single meal. By calculating the average price of the items ordered during the implementation of a particular menu scheme, coordination application 170 can determine which menu schemes result in the highest average price per item. The menu scheme having the highest average price per item can be considered, from a certain perspective, to be a preferred or optimal menu scheme, because the higher average price per item indicates increased interest in the particular menu scheme. In a similar vein, calculating the highest average price per order (that is, the total of all of the various items selected during a given meal) can similarly indicate which menu scheme(s) are of greatest interest to diners. Another indicator that can be considered is the frequency with which a given previously ordered item is re-ordered by the same party over the course of a single meal. If a member of a dining party initially orders a particular item, and then subsequently a member of the same dining party orders the same item again, this is a strong indication that this item is particularly appreciated by the diners. As such, tracking the frequency of such an occurrence, and comparing the frequencies of such an occurrence across the various menu schemes can enable coordination application 170 to determine which menu scheme(s) are preferable and/or optimal.

At this juncture, it should be understood that the process of substituting display schemes and/or menu schemes can be repeated any number of times in order to experiment with various combinations of display schemes and menu schemes. In doing so, the coordination application can further compare each respective display scheme and menu scheme (and their associated revenue drivers) with previously implemented display schemes and/or menu schemes, in order to determine one or more optimal display schemes and one or more optimal revenue schemes for restaurant 115. For example, coordination application 170 can determine, based on the various referenced comparisons, which combination of display scheme and menu scheme is optimal for lunch time, and which combination of display scheme and menu scheme is optimal for dinner time.

At step 650, one or more respective sets of revenue drivers 136 can be received from remote machines 220 that are in communication with local machine 105. These revenue drivers can be similar to the revenue drivers referenced above with respect to restaurant 115 and local machine 105, except that the revenue drivers that are received from remote machines 220 originate at remote restaurants, such as restaurants 115A-C depicted in FIG. 5.

Then at step 655, the revenue drivers received from the remote machines 220 can be compared to the various revenue drivers (such as the first and second sets of revenue drivers referenced above) stored at storage 190 of local machine 105. In doing so, coordination application 170 functions in a substantially similar way to that described above with respect to step 645, by ascribing weightings to the various revenue drivers, comparing and/or combining the remote revenue drivers and weightings with the revenue drivers and weightings stored at local machine 105, thereby transforming the data into a metric that can determine one or more preferred or optimal display schemes and/or one or more preferred or optimal menu schemes. It should be further understood that coordination application 170 can additionally compare revenue drivers originating from one remote machine (e.g., remote machine 220A in FIG. 5) with revenue drivers originating at another remote machine (e.g., remote machine 220C). Such an arrangement can be particularly appreciated with respect to FIG. 5 where one of the central functions of central machine 210 is to receive revenue drivers from the various remote machines 220A-C and to compare them with one another in order to determine one or more preferred or optimal display schemes and/or one or more preferred or optimal menu schemes based on the revenue drivers provided by the various remote machines 220A-C.

At this juncture, it should be noted that although the various revenue drivers 136 referenced herein have been described primarily with respect to display schemes and/or menu schemes that are implemented within dynamic restaurant experience system 100, in certain arrangements other revenue drivers which are relatively independent of a particular display or menu scheme can be considered and compared by coordination application 170 as well. Examples of revenue drivers that are relatively independent of display and/or menu schemes include the time of day that diners frequent the restaurant, demographic information (e.g., average age, income, education level, etc.) of the area surrounding the restaurant, and the payment method used by diners (e.g., cash or credit card). These (and other) revenue drivers can further provide insight into determining preferred and/or optimal display and/or menu schemes, even though these revenue drivers are not directly linked to a particular display and/or menu scheme being presently implemented within dynamic restaurant experience system 100. By way of illustration, based on demographic information that indicates that a large number of senior citizens live in close proximity to a given restaurant, coordination application can determine that display and/or menu schemes that appeal to such a population are preferable to those that appeal to a younger demographic. In a related vein, such additional revenue drivers can be considered by coordination application 170 in determining optimal or preferred schemes for a given restaurant. That is, while certain schemes may be preferred/optimal for a restaurant in one location (having a certain demographic makeup), such schemes may not be preferred/optimal for a restaurant located in an area with a different demographic makeup.

Upon performing the various comparisons and determinations based upon the received revenue drivers, at step 660 local machine 105 outputs one or more preferred and/or optimal display schemes and/or one or more preferred and or optimal menu schemes. In certain arrangements, the preferred/optimal schemes are output to the local machine 105 (that is, to the operator of the local machine 105, such as the owner of restaurant 115 and/or to the administrator of dynamic restaurant experience system 100) while in other arrangements the preferred/optimal schemes can be output to the remote machines 220. It should further be understood that in certain arrangements the preferred/optimal schemes can be output automatically (that is, upon determination of the preferred/optimal schemes), which in other arrangements the preferred/optimal schemes can be output in response to a query. By way of example, remote machine 220 can transmit an inquiry to local machine 105 (or central machine 210) requesting an optimal scheme for lunch hours.

It should be appreciated that a compensation or reward framework can be employed in conjunction with dynamic restaurant experience system 100, such that information relating to preferred/optimal display and/or menu schemes can be received and/or provided on the basis of certain conditions. By way of example, in one scenario remote machines employing dynamic restaurant experience system 100 can be required to transmit their generated revenue drivers to local machine 105 (or central machine 210) in exchange for the right to implement dynamic restaurant experience system 100 in their restaurant space. However, in certain scenarios the ability to receive information pertaining to preferred and/or optimal schemes can be dependent on some additional compensation (e.g., payment of addition funds).

Additionally, it should be appreciated that new display schemes 132 and menu schemes 134 can be uploaded to local machine 105 at any time. In doing so, dynamic restaurant experience system 100 can continuously update itself with new schemes that provide new dining experiences. Moreover, an authoring tool can be included among software modules 130, and this authoring tool can be further employed, whether at local machine 105 or at any remote computer or device such that new display schemes and/or menu schemes can be created.

By way of example, using an authoring tool a user can create a new display scheme for a “theme night” to be hosted at restaurant 115, such as a ‘Star Trek’ theme night. Using the authoring tool, a display scheme can be created, incorporating visual arrangements (such as images and videos), lighting schemes, and audio schemes that are to be depicted across the various presentation devices 165 to create a ‘Star Trek’ atmosphere within the restaurant 115 during the theme night. Similarly, a corresponding menu scheme can be created by creating food items (as well as corresponding preparation instructions) that reflect the ‘Star Trek’ theme (e.g., a ‘Klingon’ burger, ‘Mr. Spock’ fries, etc.). In doing so, the dynamic restaurant experience system 100 can enable the entire restaurant space to be quickly and easily customized to the particulars of a specific event (e.g., a party, theme night, reunion, etc.), and can be similarly returned to its normal operating state almost immediately upon the conclusion of the event.

Additional functionality that can be enabled through the implementation of dynamic restaurant experience system 100 is the ability to project targeted advertisements to customers through the various presentation devices 165. By way of example, ads for a car manufacturer such as BMW or a soft drink producer such as Coca-Cola can be incorporated into a given display scheme in order to generate additional revenue for the restaurant 115. For instance, in a display scheme that provides an immersive multimedia experience of a sidewalk café in Paris, a BMW car driving down the street can be periodically inserted into the visual arrangements of the display scheme, while a Coca-Cola sign is shown in the window of one of the shops on the street. In doing so, subtle advertisements can be inserted into the display scheme (thereby generating revenue for the restaurant) without detracting from the immersive multimedia experience provided by dynamic restaurant experience system 100.

By way of further example, when dynamic restaurant experience system 100 is implemented in a seating booth 125 within restaurant 115, the diners seated at a given booth can be given the option of being subjected to periodic advertisements on the various presentation devices 165 within their booth 125 (e.g., the display screens 167 and/or the audio output devices 168) in return for having a certain discount deducted from their final bill, or in return for receiving a free menu item or any other such incentive. In doing so, the dynamic restaurant experience system 100 can enable diners to choose to receive additional incentives in return for being subjected to various periodic advertisements depicted through presentation devices 165.

In addition, an auction/bidding framework can be implemented in conjunction with dynamic restaurant experience system 100, such that various entities (such as companies wishing to present advertisements within dynamic restaurant experience system 100) can bid on various slots that are designated for advertising. By way of example, based on collected revenue drivers it can be determined that a particular restaurant generally attracts an older population that is more frugal during lunch hours, while attracting a younger population that is more free-spending during dinner hours. Accordingly, certain types of companies may value the lunch time advertising slot more (and will bid more for such a slot accordingly), while other companies may value the dinner time slot more.

At this juncture, it should be noted that although much of the foregoing description has been directed to systems and methods that are deployed and/or implemented within the context of restaurants or other such food service establishments, the systems and methods disclosed herein can be similarly deployed and/or implemented in scenarios, situations, and settings far beyond restaurants. It can be readily appreciated that the dynamic restaurant experience system 100 can be effectively employed in practically any hospitality space, for example in a hotel lobby, a nightclub, or in a private building or home. It should be further understood that any such implementation and/or deployment is within the scope of the systems and methods described herein.

As has been noted above, central machine 210 can provide substantially similar functionality to that ascribed herein to local machine 105. Thus, any descriptions provided herein with respect to local machine 105 should be understood to apply equally to central machine 210, unless explicitly indicated otherwise.

It is to be understood that like numerals in the drawings represent like elements through the several figures, and that not all components and/or steps described and illustrated with reference to the figures are required for all embodiments or arrangements. It should also be understood that the embodiments and/or arrangements of the systems and methods disclosed herein can be incorporated as a software algorithm, application, program, module, or code residing in hardware, firmware and/or on a computer useable medium (including software modules and browser plug-ins) that can be executed in a processor of a computer system or a computing device to configure the processor and/or other elements to perform the functions and/or operations described below. It should be appreciated that according to at least one embodiment, one or more computer programs or applications that when executed perform methods of the present invention need not reside on a single computer or processor, but can be distributed in a modular fashion amongst a number of different computers or processors to implement various aspects of the systems and methods disclosed herein.

Thus, illustrative embodiments and arrangements of the present systems and methods provide a computer implemented method, computer system, and computer program product for deploying one or more dynamic experiences within a restaurant. The flowchart and block diagrams in the Figures illustrate the architecture, functionality, and operation of possible implementations of systems, methods and computer program products according to various embodiments and arrangements. In this regard, each block in the flowchart or block diagrams can represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof.

It should be noted that use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

The subject matter described above is provided by way of illustration only and should not be construed as limiting. Various modifications and changes can be made to the subject matter described herein without following the example embodiments and applications illustrated and described, and without departing from the true spirit and scope of the present invention, which is set forth in the following claims.

What is claimed is:

1. A computer-implemented method for deploying one or more dynamic experiences within a restaurant using a local machine, the local machine having a processor, a memory, and a coordination application stored in the memory and executing in the processor, the local machine further being in communication with one or more computing devices and a plurality of presentation devices affixed to a structure of the restaurant, the method comprising:
loading a first display scheme into the memory for depiction on the presentation devices, the first display scheme having one or more coordinated visual arrangements capable of being depicted across the presentation devices to provide a first multimedia experience to the restaurant;
transmitting a first menu scheme to the computing devices, the first menu scheme being correlated to the first display scheme and comprising one or more food items for selection;
monitoring a first set of revenue drivers at the local machine, the first set of revenue drivers comprising one or more indicators relating to a revenue calculation for the restaurant and in association with at least one of the first display scheme and the first menu scheme;
after a time interval, substituting with the coordination application a second display scheme for the first display scheme, the second display scheme having one or more coordinated visual arrangements capable of being depicted across the presentation devices to provide a second multimedia experience to the restaurant that is different than the first multimedia experience;
transmitting the second menu scheme to the computing devices, the second menu scheme being correlated to the second display scheme and comprising one or more food items for selection, at least one of which is different than the one or more food items of the first menu scheme;
monitoring a second set of revenue drivers at the local machine, the second set of revenue drivers comprising one or more indicators relating to a revenue calculation for the restaurant and in association with at least one of the second display scheme and the second menu scheme;
comparing the first set of revenue drivers with the second set of revenue drivers to determine at least one of an optimal display scheme and an optimal menu scheme for the restaurant; and
outputting at least one of the optimal display scheme and the optimal menu scheme.

2. The method of claim 1, wherein the structure comprises a seating booth within the restaurant and wherein at least one of the first multimedia experience and the second multimedia experience comprises an immersive multimedia experience within the seating booth.

3. The method of claim 1, wherein the local machine further includes a menu preparation application and is further in communication with an order preparation terminal, the method further comprising:
receiving one or more item selections from the one or more computing devices, the item selections corresponding to at least one base ingredient and one or more particular preparation instructions, the particular preparation instructions being correlated to at least one of the first menu scheme and the second menu scheme; and
providing a notification at the order preparation terminal, the notification corresponding to the item selections and comprising the at least one base ingredient and the one or more particular preparation instructions.

4. The method of claim 1, wherein the local machine is in communication with remote machines located at a plurality of restaurants, the method further comprising:
receiving respective sets of revenue drivers from each of the remote machines;
comparing the respective sets of revenue drivers with at least one of the first set of revenue drivers and the second set of revenue drivers to further determine one or more preferred display schemes and one or more preferred menu schemes; and
outputting the preferred display schemes and the preferred menu schemes to at least one of the local machine and the remote machines.

5. The method of claim 1, wherein the presentation devices comprise one or more lighting devices.

6. The method of claim 1, wherein the presentation devices comprise one or more display screens.

7. The method of claim 1, wherein the presentation devices comprise one or more audio output devices.

8. The method of claim 1, wherein the presentation devices comprise one or more odor creation devices.

9. The method of claim 1, wherein the menu items of the first menu scheme and the menu items of the second menu scheme can be filtered at the computing devices based on one or more criteria.

10. The method of claim 1, wherein the time interval comprises one or more selections of food items from the first menu scheme.

11. A computer-implemented method for deploying one or more dynamic experiences across a plurality of restaurants using a central machine, the central machine having a processor, a memory, and a coordination application stored in the memory and executing in the processor, the central machine further being in communication with remote machines located at the restaurants, the remote machines further being in communication with computing devices and a plurality of presentation devices affixed to respective structures of the restaurants, the method comprising:
transmitting a first display scheme and a first menu scheme to one or more of the remote machines, the first display scheme having one or more coordinated visual arrangements capable of being depicted across the presentation devices and the first menu scheme being correlated to the first display scheme and comprising one or more food items for selection;
receiving a first set of revenue drivers from one or more of the remote machines, the first set of revenue drivers comprising one or more indicators relating to a revenue calculation for a respective restaurant and in association with at least one of the first display scheme and the first menu scheme;
transmitting a second display scheme and a second menu scheme to one or more of the remote machines, the second display scheme being different from the first display scheme and having one or more coordinated visual arrangements capable of being depicted across the presentation devices and the second menu scheme being different from the first menu scheme and being correlated to the second display scheme and comprising one or more food items for selection;
receiving a second set of revenue drivers from one or more of the remote machines, the second set of revenue drivers comprising one or more indicators relating to a revenue calculation for a respective restaurant and in association with at least one of the second display scheme and the second menu scheme;
processing the first set of revenue drivers from the remote machines in conjunction with the first display scheme and the first menu scheme and the second set of revenue drivers from the remote machines in conjunction with the second display scheme and the second menu scheme to determine one or more preferred display schemes and one or more preferred menu schemes; and
outputting at least one of the preferred display schemes and the preferred menu schemes to at least one of the remote machines.

12. A dynamic restaurant experience system comprising:
a processor;
a control circuit operatively connected to the processor;
a memory operatively connected to the control circuit and accessible by the processor;
a coordination application stored in the memory and executable in the processor; and
a communication interface operatively connected to the control circuit and configured for communication with one or more computing devices and a plurality of presentation devices affixed to a structure of the restaurant;
wherein the coordination application, when executed by the processor, configures the control circuit to:
load a first display scheme into the memory for depiction on the presentation devices, the first display scheme having one or more coordinated visual arrangements capable of being depicted across the presentation devices to provide a first multimedia experience to the restaurant;
transmit a first menu scheme to the computing devices, the first menu scheme being correlated to the first display scheme and comprising one or more food items for selection;
monitor a first set of revenue drivers at the local machine, the first set of revenue drivers comprising one or more indicators relating to a revenue calculation for the restaurant and in association with at least one of the first display scheme and the first menu scheme;
after a time interval, substitute with the coordination application a second display scheme for the first display scheme, the second display scheme having one or more coordinated visual arrangements capable of being depicted across the presentation devices to provide a second multimedia experience to the restaurant that is different than the first multimedia experience;
transmit the second menu scheme to the computing devices, the second menu scheme being correlated to the second display scheme and comprising one or more food items for selection, at least one of which is different than the one or more food items of the first menu scheme;
monitor a second set of revenue drivers at the local machine, the second set of revenue drivers comprising one or more indicators relating to a revenue calculation for the restaurant and in association with at least one of the second display scheme and the second menu scheme;
compare the first set of revenue drivers with the second set of revenue drivers to determine at least one of an optimal display scheme and an optimal menu scheme for the restaurant; and
output at least one of the optimal display scheme and the optimal menu scheme.
